(19) United States
(12) Patent Application Publication
(10) Pub. No.: US 2008/0309253 A1
(43) Pub. Date: Dec. 18, 2008

(54) Apparatus For Remote Control Of Lights

(75) Inventors: Ye Guanrong, Hangzhou (CN); Ye Guanlin, Hangzhou (CN); Chou Shih Bin, Shihlin (TW)

Correspondence Address: ZITO TLP, P.O. BOX 240, DAMASCUS, MD, 20872, US

(73) Assignee: Canel Lighting Co., Ltd.

(21) Appl. No.: 11/764,242

(22) Filed: Jun. 18, 2007

(51) Int. Cl. H05B 37/02

(52) U.S. Cl. 315/294

(57) ABSTRACT

A multi-light control system with a single wireless remote control. A number of separate lights, such as fixtures or lamps, are individually plugged into and controlled by a control module. One control module can turn a light on or off, another module functions as a continuous dimmer, a third acts as a three level wattage switch. The single controller has a number of buttons or keys for individually activating the separate control modules.

### BACKGROUND OF THE INVENTION

The present invention relates to devices for controlling lights. More specifically, the present invention relates to a single device for dimming lights, controlling three way lights and for control of standard lights.

### SUMMARY OF THE INVENTION

A wireless controller is used to activate one or more remote modules which control overall and/or individual features of a number of remote modules to effect a change in one or more lights attached to each of said modules. Light fixtures and/or lamps can be attached to one of the modules for control by the wireless controller.

In the exemplary embodiment taught herein, a first one of the remote modules is a dimmer controller. By actuating the corresponding button on the remote controller corresponding to the dimmer control module, the dimmer control is activated to brighten or dim any light electrically connected to the remote dimmer module. In the exemplary embodiment illustrated, as long as the dimmer button on the wireless unit remains activated, the light will dim or brighten. The users continues to actuate the button until the desired level of light is achieved. After the light is turned off, the light level is retained so that when the light is again on, it will turn on at the same brightness as when it was last turned off.

A second one of the remote modules in the exemplary embodiment is used to control a three way socket, cycling between wattage settings to control amount of the wattage provided to any light attached to the module. This module can be used to achieve different light levels which can be accomplished by use of any three way, multi-filament bulb.

A third exemplary module has only an on and off mode of activation. This module can be used if the end user has no need for dimming or for different light levels.

### BRIEF DESCRIPTION OF THE DRAWINGS

For a better understanding of the nature of the present invention, reference is had to the following figures and detailed description, wherein like elements are accorded like reference numerals, and wherein:

FIG. 1 is a block diagram illustrating the major components of the controllers and the interaction of the modules of the present invention

FIG. 2 is a perspective view of the wireless control unit.

FIG. 3 is a schematic diagram of the dimmer control module.

FIG. 4 is a schematic diagram of the three way control module.

FIG. 5 is a schematic diagram of the on/off control module.

### DETAILED DESCRIPTION OF PREFERRED

### Exemplary Embodiments

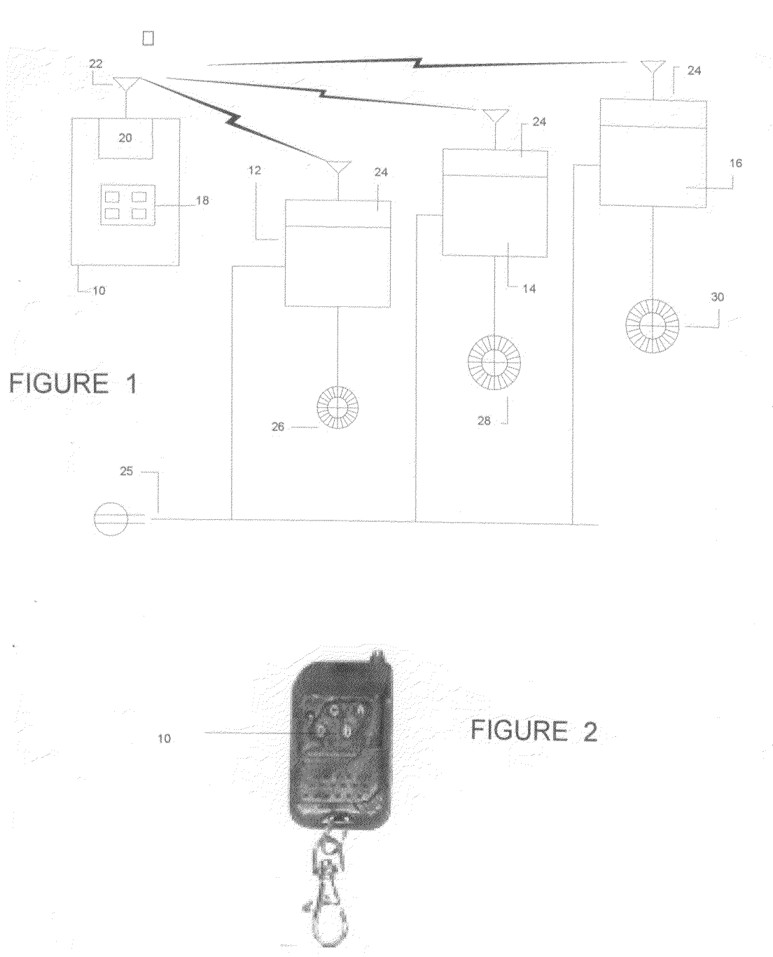

The exemplary embodiment of the control system if the present invention, as illustrated in FIG. 1, includes a wireless controller 10 and one to three wireless light control modules 12, 14 and 16. The wireless controller 10 includes a keypad 18 for accepting user input, such a selection and actuation of a control button. The wireless signals indicating the user input. The Signals may be digital or analog encoded of may be frequency or amplitude modulated to indicate user selection. Each of the light control modules includes a receiver circuit 24 corresponding to the transmission circuit 20 and an antenna appropriate for reception of the signal from the wireless controller 10.

Light control modules 12, 14, and 16 are each connected between a power source 25, such as standard AC wall current, and a light 26, 28 and 30, for control of the actuation of the individual lights.

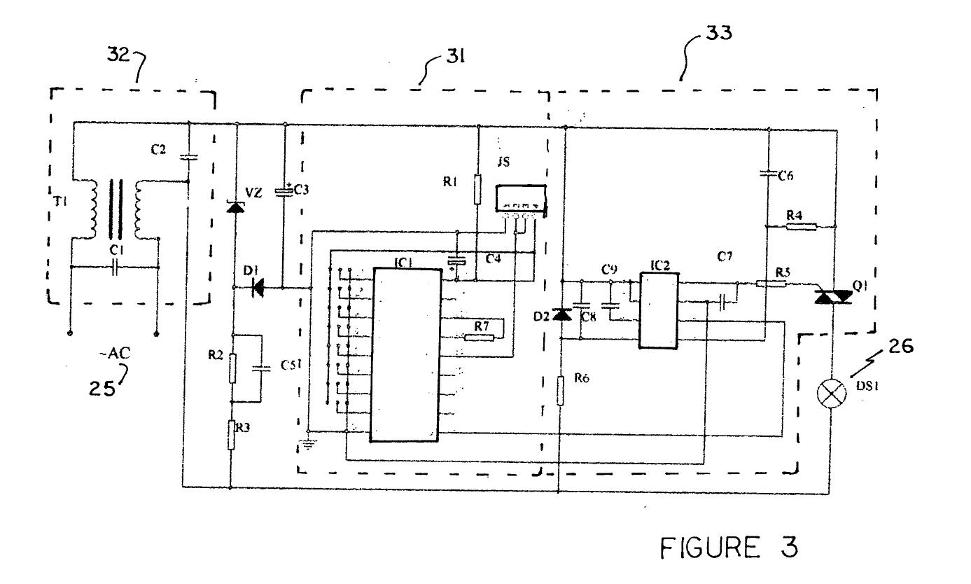

The dimmer control unit 12 is illustrated in FIG. 3. The circuit includes a wireless remote receiving portion 31, which includes IC1, JS, R1, R7 and C4. A standard remote control receiving antenna assembly 24 for receiving signals from wireless unit 10 is connected to the circuit as JS.

When the frequency of a signal is received by the antenna section 24, from the wireless control 10 at 390 MHz and of sufficient duration, the signal of a remote instruction will be demodulated, amplified and reshaped, and output. The signal is first processed in a lock-loop decoder. The signal is input to pin 14 of IC1 and decoded. If the decoded frequency from R7 is in accordance with the input signal, the pin 10 of IC1 becomes a low level, and then the high level will be sent to integrated circuit of dimmer at pin 6 of IC2. When the duration time is shorter than a threshold time, for example about 399 ms, IC2 can be operated as On/Off for Load 26, i.e. light on or light off. If the duration time of keying is longer than the set threshold, then continuous stepless dimming is implemented as long as the key remains activated. Once the key is released, the brightness of the lamp will be held.

Alternating current is received at input AC and conditioned using an EMC filter circuit 32 which includes C1, C2 and common mode choke or inductance, to suppress conducted interference and/or voltage disturbance which could cause interference with the proper operation of the control circuitry. The specification for filtering is satisfied with the standard of CISP R15 and EN551015 on electric appliance interference technologies by the International Electronics Commission IEC.

The integrated dimming circuit portion 33 includes IC2, C6, C7, C8, C9, R4, R5, R6 and D2. When a high level signal is received as an input on pin No.6 of IC2, the IC2 controls the trigger time of Q1, depending on the duration time of the signal on pin 6, the device can be operated as an ON/OFF switch or as a dimmer. Continuously variable dimming is achieved which corresponds to the keying duration of the corresponding switch in keypad 18 of wireless remote 10. The trigger time of Q1 will control the brightness of the light 26 attached as the load on the circuit between the AC sourced 25 and the dimmer control.

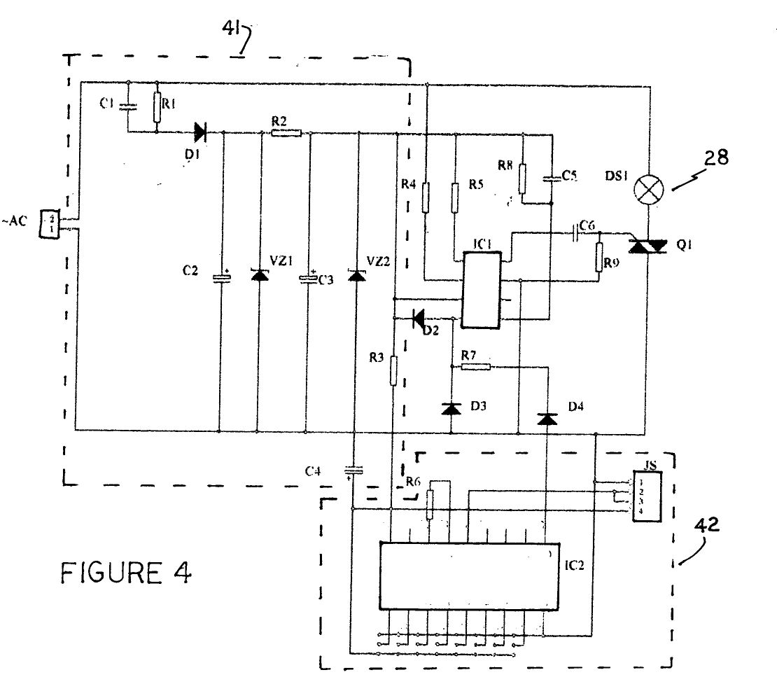

The power supply circuit 41 of the three way control unit of FIG. 4 is C1, C2, C3, C4 R1, R2, R3, D1, VZ1, VZ2 with regulated DC power source supplied to IC1, IC2 and JS.

IC1, D2, D3, D4, D5, R5, R7, R8, R9, C5, C6, Q1 form the control circuit which operates to switch the light 28 between the three wattage levels. The wireless remote receiving module 42 includes IC1 and R6 and connector JS. An antenna 24 is connected to the circuit at JS.

In operation, when a remote instruction of 300 MHz is received from transmitter 10, the instruction will be demodulated, amplified, and reshaped. The signal is received by IC1 and an output from the pin 4 of the IC1 is raised high. The output from pin4 is used in the phase lock loop decoder. The signal is sent to pin 10 of IC2 becomes low level, and sends high signal to pin 4 of IC1. If the duration time is less that 339 ms, IC1 counts and stores the data and pin 8 of the IC1 drives the output for Q1. According to above principle, the four operations of the light 28 are commanded by the wireless remote 10 so as to generate the three way actuation and off as a fourth mode.

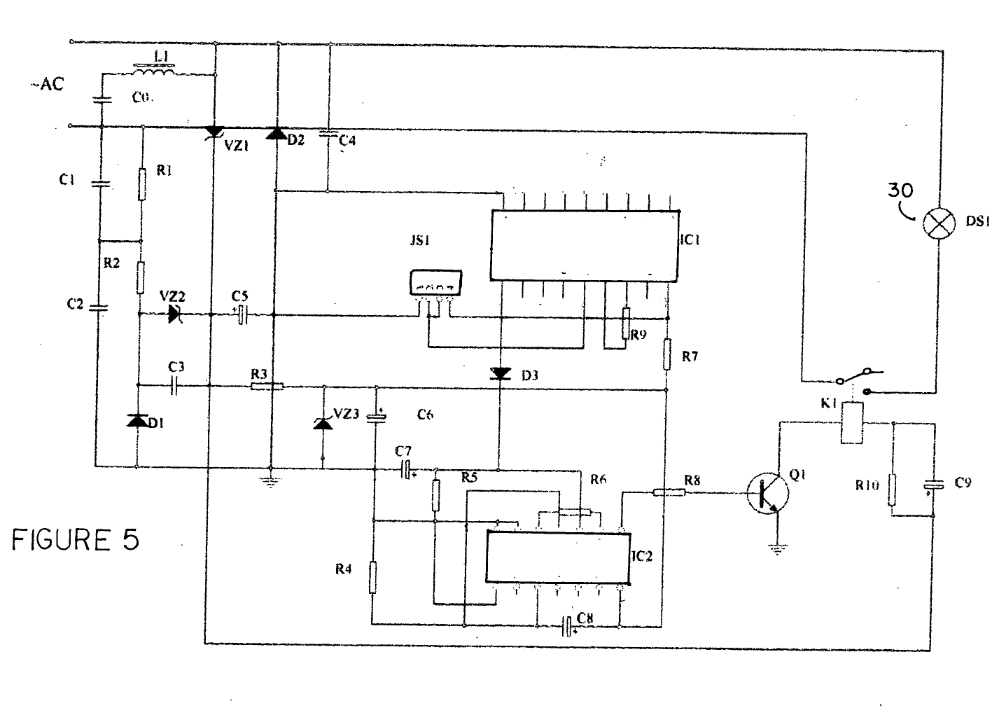

The On-Off controller, illustrated in FIG. 5, is capable of controlling a number of independent lights. The exemplary embodiment of FIG. 5 illustrates only a signal channel, pin 10 of IC1, connected to control a light, however, the circuits of the other three channels, pins 11, 12 and 13 operate using the same principle, only channel 10 is illustrated.

In operation, a receiving antenna module 24, is connected to JS1, providing inputs to pins 14 and 18 of IC1. Pin 10 of IC1 is the output of a decoded signal. Pins 10-13 are the latched data output pins of IC1. The output level of pins 10-13 is 5V(high level), the driving current is about little more than 2 mA. Pin 10-13 of IC1 can correspond to four buttons on the keypad 18 of the wireless controller 10. When a particular button is depressed, a signal corresponding to the depressed button will be sent out. When the data signal is received, the receiving unit will lock the data and then give a high level to the corresponding pin. The remaining pins will be at low level. When the receiver no longer detects the signal, the output original signal on the corresponding pins will be locked. When the signal is again received, the pins of IC1 are no longer locked and the pin corresponding to the signal will switch high to low or low to high.

Once pin 10 of IC1 latches to a high output, pins 5 and 2 of IC2 are triggered and establish a bistable mode state. The pin 10 high output is the trigger pulse sending a high level through D3 to pin 3 of IC2 of double stable state trigger, reversing the stable state of the trigger, thus operating relay K1 and the contacts are closed to actuate light 30. After the key is released, pin 10 of IC1 is still locked at a high level, but pin 18 of IC1 is at a low level. also high operates to clamp pin 3 of the bistable circuit of IC2 at a low level. The duration of the width of high level pulse at D3 is equal to the actuation of the button. While D3 remains low, the relay K1 remains actuated. When the key on the controller 10 is again actuated, pin 10 of IC1 will again go high, D3 and therefore pin 3 of IC2 also is again high. The bistable circuit is reversed and relay K1 released. The sequence can be repeated again and again to control the on and off of the lamp 30.

The power supply from 25 is lowered and regulated by a circuit which includes C0, C1, C2, C3, C4, R1, R2, D1, VZ1 and VZ2 and to reduce the voltage output to Dc 6V for circuit elements while providing AC power for the light 30.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. An apparatus for control of lights, comprising:
a wireless controller having a transmit circuit and a set of actuation keys;
a first light control module having a receive circuit, a power circuit and a control circuit, connected between a power source and a light;
a second light control module having a receive circuit, a power circuit and a control circuit, connected between a power source and a second light;
wherein, a first one of said keys activates said wireless controller to generate a signal for said first light control module, and
wherein, a second one of said keys activates said wireless controller to generate a signal for said second light control module.

2. The apparatus of Claim 1, wherein:
said control circuit of said first light control module includes a dimmer circuit.

3. The apparatus of Claim 1, wherein:
said control circuit of said light control module includes a three way switch circuit.

4. The apparatus of Claim 1, wherein:
said control circuit of said first light control module includes an on/off switch circuit.

5. An apparatus for control of lights, comprising:
a wireless controller having a transmit circuit and a set of actuation keys;
a first light control module having a receive circuit, a power circuit and a control circuit for continuous dimming of a first light, connected between a power source and a said first light;
a second light control module having a receive circuit, a power circuit and a control circuit for three way switching of a light, connected between a power source and said second light;
a third light control module having a receive circuit, a power circuit and a control circuit for on/off control of a third light, connected between a power source and a third light;
wherein, a first one of said keys activates said wireless controller to generate a signal for said first light control module,
wherein, a second one of said keys activates said wireless controller to generate a signal for said second light control module, and
wherein, a third one of said keys activates said wireless controller to generate a signal for said third light control module.
